(19) United States
(12) Patent Application Publication
(10) Pub. No.: US 2021/0387908 A1
(43) Pub. Date: Dec. 16, 2021

(54) ENHANCED HYDRATE PRODUCED FROM FLASH CALCINED LIME AND METHODS OF MAKING THE SAME

(71) Applicants: Martin L. Gran, Chesterfield, MO (US); Randy Griffard, St. Mary, MO (US)

(72) Inventors: Martin L. Gran, Chesterfield, MO (US); Randy Griffard, St. Mary, MO (US)

(21) Appl. No.: 17/348,625

(22) Filed: Jun. 15, 2021

Related U.S. Application Data
(60) Provisional application No. 63/039,149, filed on Jun. 15, 2020.

(51) Int. Cl. C04B 2/02; B01J 6/00; B01J 37/04; B01J 35/10; B01J 20/04

(52) U.S. Cl. CPC C04B 2/02; B01J 6/001; B01J 20/041; B01J 35/1014; B01J 37/04

(57) ABSTRACT

A system and related methods for the production of lime sorbent compositions from a calcium carbonate feedstock formed using flash calcination to produce the intermediate calcium oxide material.

### CROSS REFERENCE TO RELATED APPLICATION(S)

This application claims the benefit of U.S. Provisional Patent Application Ser. No. 63/039,149, filed Jun. 15, 2020, the entire disclosure of which is herein incorporated by reference.

### BACKGROUND OF THE INVENTION

### Field of the Invention

This disclosure relates to the field of producing calcium hydroxide (Ca(OH)₂), also known as lime hydrate or hydrated lime. More specifically, this disclosure relates to producing enhanced calcium hydroxide using flash calcined lime as a precursor in a process for making high reactivity calcium hydroxide (HRH).

### Description of the Related Art

Calcium oxide (CaO), which is commonly referred to as quicklime (or even just lime), is an incredibly useful compound with a storied history in a variety of industrial applications in all sorts of areas. Exemplary uses for calcium oxide range from many years ago where calcium oxide was heated to produce stage lighting (where the term “lime light” comes from) and as a building mortar for stone structures, to more modern uses where calcium oxide is an essential component of building materials such as cement, concrete, and plaster.

Calcium oxide may also be used to produce calcium hydroxide, which is another useful compound. For example, calcium hydroxide may be used industrially as a flocculant in various processes including water and sewage treatment. Other uses for calcium hydroxide include the production of ammonia gas, the production of sodium hydroxide, and the scrubbing of acid gases from industrial exhaust gas streams. An example of the latter is the use of calcium hydroxide to react with sulfur/oxygen compounds (SOₓ) often present in exhaust gas streams to produce, for example, calcium sulfate and water. Such a process is disclosed in U.S. patent application Ser. No. 16/511,168, the entire disclosure of which is incorporated herein by reference.

Calcium hydroxide particulate compounds have traditionally been manufactured according to commonly known and utilized processes. For example, a lime feed (e.g., limestone, which contains calcium carbonate) may first be heated in a lime kiln to a temperature above about 825° C. where calcium oxide is formed in accordance with the following formula:

CaCO₃(s)→CaO(s)+CO₂(g)

The calcium oxide is then continuously grinded using a pulverizing mill until a certain percentage of all the ground particles meet a desired size (e.g., 95% or smaller than 100 mesh). Second, the calcium oxide meeting the desired size requirements is then fed into a hydrator, where the calcium oxide reacts with water (also known as slaking), and then quickly dried to form calcium hydroxide in accordance with the following equation:

CaO(s)+H₂O(l)→Ca(OH)₂(s)

Finally, the resultant calcium hydroxide may then milled and classified until it meets a desired level of fineness or surface area for the target process.

As can be seen from the above, physical properties of the resultant calcium hydroxide particulate compound such as, but not limited to, particle size distribution, mean particle size, amount of calcium hydroxide versus other compounds, and other “structural” factors are often dictated by two primary elements of the process: the composition of the initial lime feed and the resultant milling and classifying processes.

The reaction of a particulate calcium hydroxide composition with an acid gas (such as SOₓ) is generally assumed to follow the diffusion mechanism. The acid gas removal is the diffusion of acid gas from the bulk gas to the sorbent particles. Thus, the total surface area of the composition (which is related to the mean particle size and particle size distribution within the composition) is believed to be very important. Specially, increased surface area implies faster reaction time and, thus, compositions with particles which are smaller than compositions with particles which are larger should be more reactive and better at acid gas mitigation. However, in practice, while high surface area (as represented by smaller particle size) is important, a small particle size composition alone has proven to not warrant a prediction of improved removal of acid gases. Thus, the old wisdom on how to make calcium hydroxide more reactive (which is simply to grind it into smaller and smaller particles) does not really work.

Instead, surface area of a calcium hydroxide particulate composition has now turned to a more sophisticated calculation which takes into account the shape of the particles within the composition to better determine the composition's reactivity to acid gases when injected as a dry sorbent. This calculation is referred to as the “BET surface area” of the calcium hydroxide particulate composition. BET surface area is generally a determination of surface area based on the theories of Stephen Brunauer, Paul Hugh Emmett, and Edward Teller (commonly called BET theory and discussed in S. Brunauer, P. H. Emmett and E. Teller, J. Am. Chem. Soc., 1938, 60, 309, the entire disclosure of which is herein incorporated by reference). This methodology particularly focuses on the available surface area of a solid for absorbing gases—recognizing that surface area, in such circumstances, can be increased by the presence of pores and related structures. BET surface area, therefore, takes into account that the total surface area of a spray of particles is not only dependent on the size of the particles, but is dependent on their “shape,” in that particles with lots of holes (pores) can have a greater surface area than their size would imply.

Because of the recognition that BET surface area is a better indicator of available surface area for reaction, commercially available calcium hydroxide products have focused on obtaining calcium hydroxide with particularly high BET surface areas, and this is believed to be necessary to provide for effective absorption. It is generally believed that the BET surface area should ideally be above 20 m²/g to be effective for acid gas removal, and in many recent calcium hydroxide compositions the BET surface area is above 30 m²/g to attempt to continue to improve efficiency. Two examples of calcium hydroxide compositions with increased BET surface areas are described in U.S. Pat. Nos. 5,492,685 and 7,744,678, the entire disclosures of which are herein incorporated by reference.

While the industry is focused on BET surface area as a proxy for calcium hydroxide reactivity with acid gases, the BET surface area also does not seem to tell the whole story. In particular, while a BET surface area above a certain threshold seems to be necessary for good reactivity, continuing to try to increase the BET surface area has led to diminishing returns and, in fact, to a reversal of reactivity in some cases. These findings have led to a belief that not only is the total BET surface area relevant, but the actual shape and style of any pores is also important. Specifically, a high pore volume of large pores (e.g., particles with large holes in them), as well as an overall large size of these pores, has generally been believed to be required to minimize a pore plugging effect during reaction and, therefore, while BET surface area has been determined to be a reasonable proxy for effectiveness of calcium hydroxide in removal of acid gases, it is not an ideal one or a complete indicator.

When the reaction time is limited and the speed of reactivity of the calcium hydroxide particulate composition is important, as it often is for duct areas that require in-flight capture of acid gases, it appears that the external surface area of the particle may actually be more important than the internal surface area (as measured by the BET gas adsorption process). The external surface area of the distribution of particles is an indication of the actual size of the calcium hydroxide particle as opposed to its available surface area. As the external or relative surface size increases, the particle size generally decreases. In contrast to large particles that may have a high total surface area, it is the outer surface of ultrafine particles that hold most of the free reactants that are believed needed for the actual reaction used to scrub acid from gasses. Thus, one is returned to the presumption that the smaller the individual particles in the composition, the more effective the removal of acid gases.

As discussed previously, however, this does not appear to tell the whole story. In many cases extremely small particles, while having high external surface area overall, are actually less reactive than particles which are larger and have less external surface area. Because it appears to be the case that either traditional measure of surface area (smaller overall particle size or BET surface area of the composition) cannot accurately predict effective highly reactive compounds, it has become necessary to instead classify particulate compositions based on their actual acid reactivity, instead of focusing on the surface area of the composition as a proxy.

Without being bound to any particular theory of operation, the problem with utilizing surface area of particulates as a proxy for reactivity appears to be that calcium hydroxide particulate compounds are not uniform and changes (particularly to distribution of particle size and BET surface areas) within the particulate distributions may be the best predictors of actual reactivity speed during dry injection type processes for scrubbing acids from gasses. No commercially viable calcium hydroxide particulate compound for use in acid gas reactivity includes particles of uniform size or surface area as such materials are commercially impractical (if not impossible) to produce. Instead, the compounds are made up of particles with a variety of sizes and surface areas. This phenomenon is well known and is part of analysis of particulate compounds. However, it has led to an understanding that the properties of the compound viewed as a whole, and not necessarily any particular particles within it, may decide the reactivity.

Because of this, it has been desirable to determine the actual reactivity of specific calcium hydroxide particulate compounds. As discussed in U.S. patent application Ser. No. 15/344,173, the entire disclosure of which is herein incorporated by reference, in order to test reactivity of particular calcium hydroxide compounds in an embodiment, the reactivity of the compound to a weak acid (such as, but not limited to, citric acid) provides for a reactivity time that is measurable with commercial instruments. The problem with determining reaction time to stronger acids is that the reaction can often be too quick to effectively measure at laboratory scaling. Thus, it is difficult to predict compositions that will function well without performing large-scale pilot testing. In order to determine the citric acid reactivity of a particular calcium hydroxide composition, the amount of time it takes 1.7 grams of calcium hydroxide to neutralize 26 grams of citric acid is measured. As a measurement of effectiveness, it is preferred that this value be less than or equal to 10 seconds in order to have a calcium hydroxide composition which is classified as being “highly reactive.” However, in an alternative embodiment, it can be less than 8 seconds. It is more preferred that this value be 4 or less, 3 or less, 2 or less, or 1 or less. Overall, given the practical realities that production of improved material often results in a product having dramatically increased costs of production, by utilizing current manufacturing techniques and by following current emissions standards, in an embodiment, particularly effective calcium hydroxide may be made to have a value in the 2-5 second range, or, in another embodiment, in the 3-4 second range.

Highly Reactive Hydrate (or HRH) is a classification of calcium hydroxide compounds where the classification may be obtained based, in part, on citric acid reactivity. HRHs may be defined (in addition or in alternative to other methods) based on the citric acid reactivity of the compound (as discussed above) being less than 10 seconds or any of the faster time thresholds contemplated above. HRHs will also typically have BET surface areas above 20 m²/g, making them suitable for at least some uses based solely on their BET surface area. However, many HRHs will have BET surface areas above 30 m²/g and such a particularly high BET surface area can actually serve to define an HRH in some cases.

HRHs are generally capable of acid neutralization in ways that traditional calcium hydroxide (being classified, for example, by being milled and classified solely to reach a target BET surface area of the resultant composition) are not. For example, HRH can typically be used in applications which require in-flight neutralization of acid gas, and can be used in applications where a lower quantity of calcium hydroxide needs to be used to avoid clogging downstream elements of the flue duct with particulates. Traditionally manufactured calcium hydroxide, even if milled and classified to segregate a portion which meets HRH level BET surface area criteria, cannot be used in these circumstances because they simply are insufficiently reactive.

Because the traditional logic of “mill and classify” until a resultant composition with the desired BET surface area characteristic is obtained does not consistently or predictably produce HRH compositions, the obtaining of HRH compositions has previously focused on modifications to the process of producing calcium hydroxide which result in the production of HRH compositions. Such processes for producing an HRH directly are described in, for example, U.S. Pat. No. 9,517,471 and U.S. patent application Ser. Nos. 14/289,278; 14/541,850; 15/466,097; and Ser. No. 15/596,911, the entire disclosure of all of which is herein incorporated by reference. These processes produce calcium hydroxide particulate compositions that can perform as necessary to be classified as HRH, generally as identified by citric acid reactivity, BET surface area, or a combination of both. However, these processes are often more manufacturing intensive and require more stages of manufacturing than what is required for the manufacturing of traditional calcium hydroxide.

While all of the above are perfectly acceptable ways to produce HRH, it is desirable to be able to produce HRH without having to utilize any modified manufacturing methodology, but to instead utilize the traditional mill, hydrate, mill and classify process as discussed above.

One way to utilize traditional milling and hydration techniques to produce an HRH is to add compounds to non-HRH calcium hydroxide, which will typically be a calcium hydroxide having citric acid reactivity as discussed above of more than ten seconds, to make the non-HRH an HRH, which is having a citric acid reactivity of less than or equal to ten seconds. Further, these types of additions can provide for adding compounds to an already HRH calcium hydroxide, which is calcium hydroxide having citric acid reactivity as discussed above of less than 10 seconds, to increase the reactivity of the HRH to twice what it was and less than or equal to 5 seconds.

The above-discussed systems and methods herein effectively allow one to “upconvert” traditional (or non-HRH) calcium hydroxide into HRH. This type of system would allow for facilities that lack the specific machinery or techniques for producing HRH according to any more specific methodology to produce HRH by simply manufacturing calcium hydroxide by traditional processes and then turning it into an HRH. Such systems and processes are disclosed in U.S. patent application Ser. No. 16/511,168 (which is introduced and incorporated herein by reference above). Such systems and processes are also disclosed in U.S. patent application Ser. No. 16/235,885, the entire disclosure of which is herein incorporated by reference.

Additionally, to the extent that a traditional calcium hydroxide can be “upconverted” to an HRH, those same processes can be used on products which are produced as HRH using the specific methods contemplated above (or other later developed methods) to further increase the reactivity of products which are already defined as an HRH to increase the reactivity of the HRH to previously unavailable levels. This can produce what is referred to herein as Super Reactive Hydrates (SRH), a subcategory of HRH, where the citric acid reactivity can be reduced to below 5 seconds, 4 seconds, 3 seconds, 2 seconds, 1 seconds, or lower and/or the BET surface area can be increased to 40 m²/g, 50 m²/g, 60 m²/g, 70 m²/g, or higher. SRH can be useable in reactions where traditional calcium hydroxide is simply unusable due to reaction speed making SRH effectively a new option for calcium hydroxide use in a variety of industries and applications.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems, as well as a lack of systems and processes to efficiently provide reactive calcium hydroxide, in general, there is described herein a system (and related methods) for the production of HRH (and SRH) from a calcium carbonate feedstock using flash calcination to produce the intermediate calcium oxide material. These systems and methods system may be used to produce HRH, or even SRH, using known methods for producing HRH. The use of calcium oxide produced by flash calcination may provide benefits to the HRH product previously unavailable when using traditional calcium oxide forming processes.

Described herein, among other things, is a method for forming a sorbent composition with improved acid gas reactivity comprising: forming a first calcium oxide particulate in a lime kiln; forming a second calcium oxide particulate in a flash calciner; mixing said first calcium oxide particulate with said second calcium oxide particulate to form a calcium oxide particulate mixture; slaking said calcium oxide particulate mixture with water to form calcium hydroxide particles; and forming a sorbent composition from said calcium hydroxide particles; wherein said calcium hydroxide particles have a reactivity of less than 10 seconds and a BET surface area of 20 m²/g or greater; and wherein said reactivity is an amount of time it takes said calcium hydroxide particles to neutralize in citric acid, said citric acid having a mass greater than 10 times a mass of said calcium hydroxide particles.

In an embodiment of the method, the reactivity is less than 8 seconds.

In an embodiment of the method, the reactivity is less than 4 seconds.

In an embodiment of the method, the reactivity is less than 3 seconds.

In an embodiment of the method, the reactivity is between about 2 seconds and about 5 seconds.

In an embodiment of the method, the mass of said calcium hydroxide particles is about 1.7 grams and mass of citric acid is about 26 grams.

In an embodiment of the method, the sorbent composition comprises at least 95% calcium hydroxide particles.

In an embodiment of the method, the water includes an additive.

In an embodiment of the method, the additive comprises: an additive to increase BET surface area, an additive to increase reactivity, or both.

In an embodiment of the method, the additive to increase reactivity is selected from the group consisting of: sugars and lignosulfonate salts.

In an embodiment of the method, the additive to increase reactivity is between 0.75% to 1.25% of said calcium oxide particulate by weight.

In an embodiment of the method, the additive to increase BET surface area is selected from the group consisting of: glycols derived from ethylene oxide and amines produced from reacting ethylene oxide with ammonia.

In an embodiment of the method, the additive to increase BET surface area is between 0.5% to 3% of said calcium oxide particulate by weight.

In an embodiment of the method, the second calcium oxide particulate comprises at least 20% of said calcium oxide particulate mixture.

In an embodiment of the method, the second calcium oxide particulate comprises at least 40% of said calcium oxide particulate mixture.

In an embodiment of the method, the second calcium oxide particulate comprises at least 50% of said calcium oxide particulate mixture.

In an embodiment of the method, the second calcium oxide particulate comprises at least 60% of said calcium oxide particulate mixture.

In an embodiment of the method, the second calcium oxide particulate comprises at least 80% of said calcium oxide particulate mixture.

In an embodiment of the method, the second calcium oxide particulate comprises at least 90% of said calcium oxide particulate mixture.

There is also described herein, a method for forming a sorbent composition with improved acid gas reactivity comprising: forming a calcium oxide particulate in a flash calciner; slaking said calcium oxide particulate with water to form calcium hydroxide particles; and forming a sorbent composition from said calcium hydroxide particles; wherein said calcium hydroxide particles have a reactivity of less than 10 seconds and a BET surface area of 20 m²/g or greater; and wherein said reactivity is an amount of time it takes said calcium hydroxide particles to neutralize in citric acid, said citric acid having a mass greater than 10 times a mass of said calcium hydroxide particles.

### BRIEF DESCRIPTION OF THE DRAWINGS

FIG. 1 depicts a loose block diagram of an arrangement of a process for making calcium hydroxide from a source of calcium carbonate in accordance with this application.

FIG. 2 depicts an embodiment of a flash calcination process that may be used in the processing of calcium hydroxide in accordance with this application.

### DETAILED DESCRIPTION OF THE PREFERRED EMBODIMENT(S)

Each of the above described processes for producing calcium hydroxide from calcium oxide rely upon a traditional process for making calcium oxide, which is the feedstock for the making of calcium hydroxide. In each case, the calcium oxide is produced by a traditional lime kiln. Calcium oxide is typically produced by thermally decomposing limestone or seashells, each of which contains sufficient levels of calcium carbonate (CaCO₃), which is also known as calcite. The thermal decomposition of calcium carbonate may also be referred to as a lime burning process or calcination. There are a large number of different types of lime kiln designs available in modern calcium oxide production. Some designs are little changed from processes used hundreds of years ago, while others are of relatively modern design. While there are a huge number of different lime kilns, most industrial processes use one of only a relatively small number of different designs. The design of a given lime kiln is often selected based on desired output and available input, as certain types of lime kilns are better for producing calcium oxide with certain qualities and characteristics and/or for operating on certain kinds of limestone feed stocks.

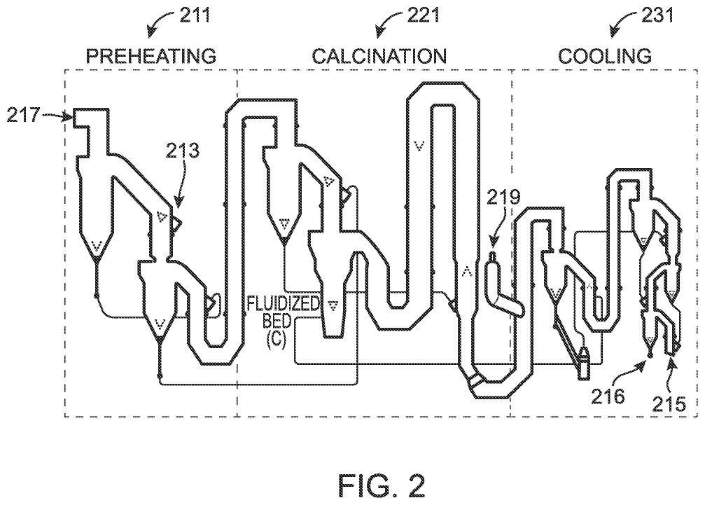

Calcination, however, may also be performed via flash calcination. Such a flash calcination process is described in, for example, the document available at the following link, the entire disclosure of which is hereby incorporated by reference: https://flsmidth-prod-cdn.azureedge.net/-/media/brochures/brochures-products/calcining-and-roasting/2018/flsmidthgassuspensioncalciner_brochure.pdf?rev=4c65027b-cae4-4416-b99f-96e1bda828c0. In the above-referenced document, the flash calcination process is referred to as a “gas suspension calcination.” As will be described further herein, in this flash calcination process (201), which is depicted in FIG. 2, calcination takes place in a stationary vertical column within a gas suspension calciner. There are typically no rotating parts or grid plates in the gas suspension calciner, and the device may use simple proportional-integral-derivative control (also known as PID control) for the addition of fuel. Typically, a lime source, such as limestone, is preheated at a first stage (211). At a second stage (221), this mixture is heated further to produce calcination. Finally, at a third stage (231), the produced calcium oxide may be cooled and collected.

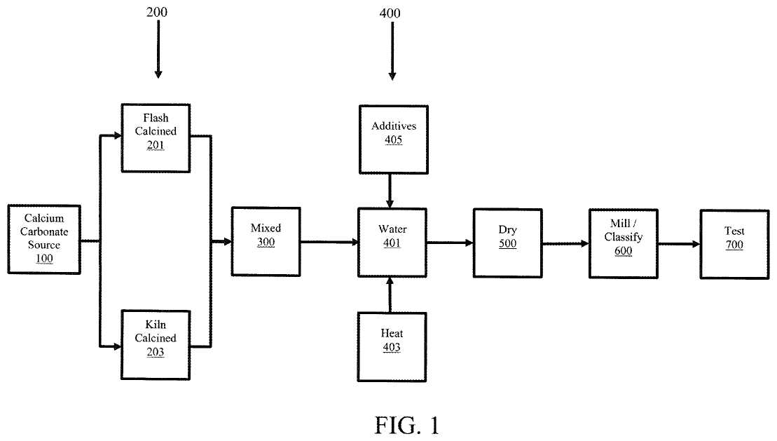

FIG. 1 depicts a loose block diagram of an arrangement of a process for making calcium hydroxide from a source of calcium carbonate. The process begins with the procurement of calcium carbonate (100) from a source of calcium carbonate. In an embodiment, such a source may be a limestone mine, quarry, or other source of calcium carbonate-baring rock. In other embodiments, the source of calcium carbonate may be seashells, other shells, or another animal-made source. In some other embodiments, the source of calcium carbonate may be precipitated calcium carbonate. In yet other embodiments, the source of calcium carbonate may simply be any commercial source of calcium carbonate. Finally, in some embodiments, the source of calcium carbonate may be any source known to persons of ordinary skill in the art.

Typically, the calcium carbonate source material will be preprocessed to have selected physical properties related to the sizing and size distribution of the particles of calcium carbonate. For example, in an embodiment, limestone may be milled, classified, and mixed to provide the desired particle size distribution, which may be any particle size distribution known to persons of ordinary skill in the art and preferred for the specific application of the limestone. For example, in an embodiment, the source of calcium carbonate will be refined using Mississippi Lime Company's known limestone processes. In other embodiments, any process for refining the limestone or other source of calcium carbonate may be used.

Once the calcium carbonate (100) has been procured, the calcium carbonate (100) may be calcined (200). At this point in the process, the calcium carbonate (100) may be calcined using one of two different processes: flash calcination (201) or lime kiln calcination (203). In either case, the calcium carbonate (100) is heated to covert the calcium carbonate (100) into carbon dioxide and calcium oxide. Although both the flash calcination (201) and the lime kiln calcination (203) steps produce the above reaction (via thermal decomposition), the resulting end products may vary slightly, typically in the physical orientation or arrangement of the particles of calcium oxide.

The process of heating calcium carbonate (100) in a lime kiln (203) will now be briefly described. As stated above, there are a large number of different types of lime kiln designs available in modern calcium oxide production. The design of a given lime kiln is often selected based on desired output and available input, as certain types of lime kilns are better for producing calcium oxide with certain qualities and characteristics and/or for operating on certain kinds of limestone feedstock.

Regardless of the design, lime kilns are generally focused on two main types of operation, rotary or vertical shaft, and utilize a continuous inflow of limestone (or other source material) and outflow of calcium oxide. Lime kiln systems are traditionally characterized by providing a counter-current flow of solids and gases and usually utilize three stages of action in the calcium carbonate thermal decomposition process. The first stage is a preheating zone, into which limestone and/or other source material added and then heated to a temperature generally above about 800° C. (about 1450° F.), typically by exposure to escaping exhaust gases from actions later in the lime kiln. In the second stage (221), or calcining zone, the limestone is heated to above about 900° C. (about 1650° F.) (and commonly about 1000° C. (about 1830° F.)) to cause the calcination. This state is typically heated directly by the application of burning fuel (such as natural gas, fuel oil, coal, petroleum coke, low heating value gases, or alternate fuels, as well as any other fuel known in the art), but this stage may also utilize exhaust gases to increase heat efficiency. The resultant calcium oxide is then cooled at the third stage (231), which is a cooling zone to prepare the calcium oxide for removal from the kiln.

The process for flash calcination (201) will now be briefly described. In a flash calcination process (201), milled limestone particles (or other source material) are rapidly calcined in an entrained-flow reactor, which is, in this context, referred to as a gas suspension calciner. As discussed above, calcination may take place in a stationary vertical column (or in a system with such columns) within the gas suspension calciner. Typically, there are no rotating parts or grid plates in the gas suspension calciner, and the device may use simple proportional-integral-derivative control (also known as PID control) for the addition of fuel. The gas suspension calciner is typically a cascading system of interconnected ductwork and cyclone chambers, wherein the ductwork has a plurality of openings for the input of particles of calcium carbonate, hot air, and relatively cool air.

The process may be described as having three main stages: a first heating stage (211), a second calcination stage (221), and a third cooling stage (231). Air will typically enter the ductwork of the gas suspension calciner proximate to the end of the process in the third stage (231) at a cooling opening (215) and at the beginning of the second stage (221) at a heating opening (219). The exhaust gas from the process will typically leave the gas suspension calciner at the exhaust opening (217). Typically, each of the cyclone chambers terminates at its bottom with a gravity fed portion of pipe that leads to one of several openings in the downstream portion of the ductwork, typically just upstream of the next cyclone chamber. This construction may be seen in FIG. 2.

Typically, small particles of a source of calcium carbonate (100), such as limestone, are preheated at a first stage (211). In some embodiments, such particles are less than one millimeter in diameter. As depicted in FIG. 2, the source of calcium carbonate (100) may be added to the process at a feedstock opening (213). The particles will typically first move vertically upwards, following the flow path of hot exhaust gas from the second stage (221). This flow path will typically deposit the particles of calcium carbonate (100) into a cyclone chamber, mixing the exhaust gas and particles of calcium carbonate (100). When the calcium carbonate (100) reaches the bottom of the cyclone chamber, it may be conveyed to the second stage (221). Such conveyance may be any conveyance known to persons of ordinary skill in the art, such as the use of gravity. In the embodiment depicted in FIG. 2, there are two cyclone chambers in the first stage (201). Thus, the calcium carbonate (100) may gravity feed from the first cyclone chamber into an area of the ducting just below the second cyclone chamber. Then, the preheated and dried calcium carbonate (100) may be gravity fed from the second stage (221). Again, other types of conveyance may be used at any point during the flash calcination process.

At a second stage (221), the particles of calcium carbonate (100) may be heated further to produce calcination. The calcination process may begin with an initial cyclone chamber that is followed by a fluidized bed reactor chamber, which chamber typically also features a cyclone action. This structure is depicted in FIG. 2. The heat for calcination is typically provided by an external air heater (not shown) that is configured to provide the source of calcium carbonate (100) being calcined with hot air. In the depicted embodiment, this heated air is introduced into the ductwork at a heating opening (219) within the ductwork. The heat for calcination may be produced by any method known in the art, including, without limitation, the combustion of any fuel material discussed above with reference to the burning of fuel in a lime kiln. In some embodiments, as discussed in more detail below, the air within the gas suspension calciner may be conditioned air that has a reduced carbon dioxide content.

In the depicted embodiment of FIG. 2, the calcium carbonate (100) may enter the ductwork of the second stage (221) at a portion of the ductwork that is just upstream from the depicted initial cyclone chamber of the second stage (221). Like the cyclone chambers in the first stage (211), the initial cyclone chamber of the second stage (221) will mix the calcium carbonate (100) with hot air in a cyclone, which hot air will typically be hotter than the hot air within the first stage (211). When the calcium carbonate (100) reaches the bottom of the initial cyclone chamber, the calcium carbonate (100) will typically gravity feed into a portion of the ductwork just upstream from the depicted fluidized bed reactor chamber. In the fluidized bed reactor chamber, the hot air will typically be hotter than the hot air within the initial cyclone chamber. Although the calcination process may begin in the initial cyclone chamber, such calcination may typically complete in the fluidized bed reactor chamber. Typically, the calcium carbonate (100) will, at this point, have been converted (at least in part) to calcium oxide. The calcium oxide may now be gravity fed into the third stage (231).

At the third stage (231), the calcium oxide may now be cooled by mixing with cooler air introduced into the ductwork at the cooling opening (215). The third stage (231) may take many different forms. In the depicted embodiment, the third stage (231) comprises four separate cyclone chambers, with each gravity feeding the calcium oxide to the next in the sequence, one after another. Eventually, when the calcium oxide reaches the end of the final cyclone chamber (216), the calcium oxide may be removed from the gas suspension calciner for further processing.

In other embodiments, other flash calcination processes may be used. Typically, all flash calcination processes will share attributes and designs that comingle calcium carbonate in a fine, powdered form with hot gas, wherein the calcium carbonate typically moves through a continuous process against the main flow direction of the hot gas. Further, typical flash calcination processes will include some form of each of the first stage (211), second stage (221), and third stage (231), discussed above with reference to the depicted embodiment of FIG. 2.

The next process depicted in FIG. 1 is the mixing of different amounts of calcium oxide from the two sources discussed above: from a lime kiln calcination process (203) and from a flash calcination process (201). As will be seen in some exemplary embodiments discussed below, calcium oxide from these two sources may be mixed in any ratio. For example, in some embodiments, the examples will be mixed in one of the following ratios for mass of lime kiln calcined calcium oxide to flash calcined calcium oxide: 100:0; 80:20; 60:40; 50:50; 40:60; 20:80; 0:100. These ratios are exemplary, however, and any other possible ratios may be used. As implied by the above ratios, only one of the two sources of calcium oxide may be used in some embodiments, and, in particular, in some embodiments, only flash calcined calcium oxide is used. Any method of mixing known to persons of ordinary skill in the art may be used.

Once the calcium oxide mixture has been prepared, the next process depicted in FIG. 1 is the mixing of the calcium oxide with water (401) to produce calcium hydroxide (400). This process may be referred to as “slaking.” As will be discussed in more detail with the following exemplary embodiments (also referred to as examples), different amounts of water may be added to the calcium oxide (401), which may provide the resultant calcium hydroxide (400) with different properties. For example, in some embodiments, that amount of water added is relatively small, and typically is only slightly more than what would be enough to provide for the reaction to form calcium hydroxide from calcium oxide (401). In such an embodiment, the unused water will typically evaporate because the reaction is exothermic. This water-lean process may be referred to herein as a dry hydrate process.

In other embodiments, more water than in the above-described process may be added to the calcium oxide (401). In this embodiment, the excess water may be allowed to remain with the newly formed calcium hydroxide mixture for a variable period of time, as would be understood by persons of ordinary skill in the art. In this process, the water may be subsequently removed from the calcium hydroxide by heating the calcium hydroxide mixture (500) at the next step of the process depicted in FIG. 1. This water-rich process may be referred to herein as a damp hydrate process.

Further, either of the two processes described above for adding water to the calcium oxide (401) may include (a) the addition of some amount of heat (403) or (b) the addition of additives (405). For example, as will be shown in the examples discussed below, the water being added to the calcium oxide (401) may be heated to a predetermined temperature (403) before being added to the calcium oxide (401). In some embodiments, this predetermined temperature may be maintained throughout the process of adding water to calcium oxide (401) to form calcium hydroxide. In other embodiments, the heat (403) may only be used to set the added water to the predetermined temperature before being used in the reaction. The predetermined temperature may be any temperature within a range of about 20° C. to about 200° C. In other embodiments, the predetermined temperature may be any temperature within a range of about 65° C. to about 180° C.

The additives may be one or more additive chosen from any additive known to persons of ordinary skill in the art. For example, the additives may be, without limitation, diethylene glycol (“DEG”), triethanolamine (“TEA”), propylene glycol (“PG”), glycerin, sugar, borax, or similar additives. Such additives may enhance the reactivity of the produced calcium hydroxide. The additives may be added to the calcium oxide or to the water before the two feedstocks are mixed in this step (400). Typically, the amount of mass of additives added will be within a range of about 0 to about 5% of the mass of the calcium oxide. In other embodiments, the amount of mass of additives added will be within a range of about 0 to about 2% of the mass of the calcium oxide. Additives may be added to either the dry hydrate process of the damp hydrate process discussed above. One or more additive may be used at a given time. In some embodiments, no additive will be added.

Next, after the water is added, an optional drying step (500) may be conducted, as discussed briefly above. Any temperature may be used to dry (500) the newly formed calcium hydrate mixture, and such a temperature may be applied over any amount of time. In some embodiments, this drying step (500) may be omitted. In an embodiment, the calcium hydroxide may be flash-dried using air from an indirect heat source with a temperature of about 550° F. to about 850° F. Using indirect heat may prevent the calcium hydroxide from contacting the combustion gas, which contact may occur if a direct heat source is used. This contact may result in the loss of some of the available calcium hydroxide. In any event, the calcium hydroxide may generally have a residual moisture content of about 1% or less.

Note that any carbon dioxide in air that comes in contact with calcium hydroxide may compromise the chemical integrity of the calcium hydroxide. While calcium hydroxide has greater moisture stability than calcium oxide, calcium hydroxide is perishable unless adequately protected from carbon dioxide absorption, and the introduction of carbon dioxide into calcium hydroxide can result in recarbonation (i.e., Ca(OH)₂ to CaCO₃) of the calcium hydroxide to calcium carbonate. Thus, in some embodiments, the chemical purity of the calcium hydroxide may be further improved if the indirect heater is supplied with conditioned air that has a reduced carbon dioxide content. Examples of apparatuses and methods for such air conditioning (i.e., reduction of carbon dioxide content in the air stream) are disclosed, for example, in U.S. Pat. Nos. 5,678,959 and 6,200,543, the entire disclosures of which are hereby incorporated herein by reference. In some embodiments, ambient air (e.g., about 300 ppm CO₂) may be fed into an air conditioner, resulting in conditioned air with a carbon dioxide concentration of less than 100 ppm carbon dioxide.

Next, after the water is added, and after the optional drying step is completed, the dry calcium hydroxide may be milled. The milling process may be any milling process known to persons of ordinary skill in the art. For example, the milling process may be any grinding or milling process, including, without limitation, milling using a fine grind cage mill, swing hammer mill, screen mill, etc., where the amount of milling produces the desired particle-size distribution.

In some embodiments, the dried calcium hydroxide may be classified and milled (600). The dried calcium hydroxide may first be fed into a classifier (600). If the dried calcium hydroxide meets the desired properties (e.g., those discussed herein, including purity reactivity, BET surface area, and particle size), the dried calcium hydroxide may be utilized as the final product. Some of the dried calcium hydroxide, however, may not meet the desired properties. This non-final calcium hydroxide may then feed into a mill to be grinded (600), with the grinded calcium hydroxide being fed back into the classifier to determine if the material may be utilized as the final calcium hydroxide product. This process of milling and classifying (600) may continue for as long as is necessary.

Again, in some embodiments, the milling and classification system may be conducted in a closed circuit system to prevent air carbonation from occurring to the calcium hydroxide. Conditioned air (i.e., low carbon dioxide air) may further be injected into the milling and classification system to replace any transient air being drawn into the process in order to prevent or reduce any recarbonation.

The above process of manufacturing calcium hydroxide describes a process in which the drying (500), classifying (600), and milling (600) of the calcium hydroxide are conducted independently. As would be understood by one of ordinary skill in the art, milling and classification systems can be, and commonly are, integrated into one system. In such an integrated system, dried calcium hydroxide may be fed into the milling/classification system with (or without) injected conditioned air, and the resultant final calcium hydroxide product may have the desired properties discussed above. Similarly, an integrated milling and classification system may be further integrated into a dryer. In such a system, the damp calcium hydroxide may be fed into the integrated milling/classification/dryer system with an indirect heat source, and the resultant final calcium hydroxide may have the desired properties discussed above.

Finally, once the calcium hydroxide has passed the milling and classifying stage (600), the resulting calcium hydroxide product may have its BET surface area tested (700). Any method of BET testing (700) may be used, as would be understood by persons of ordinary skill in the art. In some embodiments, the BET testing (700) may include determinations of one or all of the following attributes of the tested calcium hydroxide: (a) overall BET surface area, (b) pore size, and (c) pore volume. In other embodiments, more or less aspects related to the BET surface area or overall reactivity of the material being tested may be determined (700).

### Example 1

Below are two tables, Table 1 and Table 2, which tables contain the testing results of some calcium hydroxide that was produced in accordance with the processes disclosed herein and in FIG. 1. Specifically, Table 1 contains testing results for calcium hydroxide produced using a dry hydrate process, and Table 2 contains testing results for calcium hydroxide produced using a damp hydrate process.

TABLE 1

| | | | Blend | | | Pre | Post | | | |
|---|---|---|---|---|---|---|---|---|---|---|
| Kiln | Flash | | Ratio | D.I. Water | | dry | Dry | TriStar (BET) | | |
| CaO | CaO | Total | Kiln/ | | Start | Water | Water | Multi | Pore | Pore |
| (g) | (g) | (g) | Flash | (g) | Temp (C.) | (%) | (%) | Pt. | Size | Vol |
| 300 | 0 | 300 | 100% | 200 | 170 | 3.10 | 0.37 | 25.41 | 152 | 0.097 |
| 240 | 60 | 300 | 80/20 | 200 | 170 | 2.41 | 0.42 | 22.73 | 173 | 0.098 |
| 180 | 120 | 300 | 60/40 | 197 | 170 | 1.21 | 0.15 | 22.39 | 200 | 0.112 |
| 150 | 150 | 300 | 50/50 | 190 | 170 | 2.66 | 0.42 | 21.60 | 210 | 0.114 |
| 120 | 180 | 300 | 40/60 | 185 | 170 | 2.46 | 0.20 | 21.58 | 220 | 0.119 |
| 60 | 240 | 300 | 20/80 | 180 | 170 | 0.90 | 0.31 | 21.50 | 234 | 0.126 |
| 0 | 300 | 300 | 100 | 180 | 170 | 0.12 | 0.25 | 22.23 | 254 | 0.141 |

TABLE 2

| | | | Blend | | | Pre | Post | | | |
|---|---|---|---|---|---|---|---|---|---|---|
| Kiln | Flash | | Ratio | D.I. Water | | dry | Dry | TriStar (BET) | | |
| CaO | CaO | Total | Kiln/ | | Start | Water | Water | Multi | Pore | Pore |
| (g) | (g) | (g) | Flash | (g) | Temp (C.) | (%) | (%) | Pt. | Size | Vol |
| 300 | 0 | 300 | 100% | 310 | 180 | 20.50 | 0.20 | 32.39 | 206 | 0.167 |
| 240 | 60 | 300 | 80/20 | 310 | 180 | 19.63 | 0.30 | 35.88 | 201 | 0.181 |
| 180 | 120 | 300 | 60/40 | 310 | 180 | 16.90 | 0.20 | 36.01 | 208 | 0.187 |
| 150 | 150 | 300 | 50/50 | 310 | 180 | 20.20 | 0.14 | 36.74 | 206 | 0.189 |
| 120 | 180 | 300 | 40/60 | 315 | 180 | 20.00 | 0.20 | 31.56 | 187 | 0.147 |
| 60 | 240 | 300 | 20/80 | 317 | 180 | 23.58 | 0.20 | 35.11 | 235 | 0.206 |
| 0 | 300 | 300 | 100 | 320 | 180 | 18.30 | 0.18 | 32.52 | 232 | 0.188 |

For the preparations made for, and reflected in, Table 1, mixtures of calcium oxide calcined in a lime kiln (“Kiln” in the tables) and calcium oxide calcined by flash calcination (“Flash” in the tables) were prepared in the listed ratios, wherein each mixture amounted to a total of about 300 g of calcium oxide. The mixtures were then introduced to between about 180 g and about 200 g of water at about 170° C. The water and the mixtures were mixed in a bowl using a spatula in order to produce calcium hydroxide. The moisture content of the resulting calcium hydroxide mixture was then determined. Subsequently, the calcium hydroxide mixture was dried, and the moisture content of the dried calcium hydroxide was then determined. After drying, the dry calcium hydroxide was milled. Finally, the BET surface area of the dried and milled calcium hydroxide was determined.

As can be seen in the testing shown in Table 1, the multi-point BET surface area determination lowered as more flash calcined calcium oxide was used to prepare the tested calcium hydroxide prepared using a dry hydrate method. Further, the determined pore size rose considerably with larger amounts of flash calcined calcium oxide being used, and, in some cases, this rise was as much as about 67% of the pore size of the calcium hydroxide made from only lime kiln calcined calcium oxide. Similarly, the pore volume typically increased with larger amounts of flash calcined calcium oxide being used. Accordingly, the use of flash calcined calcium oxide may increase the reactivity of subsequently produced calcium hydroxide.

For the preparations made for, and reflected in, Table 2, mixtures of calcium oxide produced by a lime kiln and calcium oxide produced by flash calcination were prepared in the listed ratios, wherein each mixture amounted to a total of about 300 g of calcium oxide. The mixtures were then introduced to between about 310 g and about 320 g of water at about 180° C. The water and the mixtures were mixed in a bowl using a spatula in order to produce calcium hydroxide. The moisture content of the resulting calcium hydroxide mixture was then determined. Subsequently, the calcium hydroxide mixture was dried, and the moisture content of the dried calcium hydroxide was then determined. After drying, the dry calcium hydroxide was milled. Finally, the BET surface area of the dried and milled calcium hydroxide was determined.

As can be seen in the testing shown in Table 2, the multi-point BET surface area determination fluctuated up and down as more flash calcined calcium oxide was used to prepare the tested calcium hydroxide using a damp hydrate method. The determined pore size generally stayed relatively consistent until the amount of flash calcined calcium oxide rose to 80% or more of the mixture, at which time the pore size appears to have risen significantly. On the other hand, the pore volume generally increased with larger amounts of flash calcined calcium oxide being used. There was one exception for the calcium hydroxide prepared with 60% flash calcined calcium oxide, which result may have been an aberration or is otherwise unexplained by the information in the tables. Accordingly, the use of flash calcined calcium oxide may increase the reactivity of subsequently produced calcium hydroxide.

### Example 2

Below are seven tables, Table 3, Table 4, Table 5, Table 6, Table 7, Table 8, and Table 9, which tables contain the testing results of some calcium hydroxide that was produced in accordance with the processes disclosed herein and in FIG. 1. Specifically, Table 3 contains testing results for calcium hydroxide produced using a dry hydrate process with no additives added. Table 4 contains testing results for calcium hydroxide produced using a dry hydrate process with DEG added. Table 5 contains testing results for calcium hydroxide produced using a dry hydrate process with TEA added. Table 6 contains testing results for calcium hydroxide produced using a dry hydrate process with propylene glycol added. Table 7 contains testing results for calcium hydroxide produced using a dry hydrate process with glycerin added. Table 8 contains testing results for calcium hydroxide produced using a dry hydrate process with sugar added. In each of the above tables, the related calcium hydroxide tested was produced using either lime kiln calcined calcium oxide or flash calcined calcium oxide. Table 9, on the other hand, contains testing results for calcium hydroxide produced using a damp hydrate process, some of which includes the additive DEG, and all of which was produced using flash calcined calcium oxide.

TABLE 3

| | | D.I. Water | | Additive | | | | | | | |
|---|---|---|---|---|---|---|---|---|---|---|---|
| | CaO | | Start | | | | Water | Pre dry | TriStar (BET) | | |
| Type | wt. | | Temp | | | % of | or | Water | Multi | Pore | Pore |
| Lime | (g) | (g) | (C.) | Type | (g) | CaO | Lime | (%) | Pt. | Size | Vol. |
| Kiln | 300 | 200 | 150 | NONE | | | | 0.13 | 21.61 | 178 | 0.096 |
| Flash | 300 | 200 | 150 | NONE | | | | 1.30 | 22.92 | 253 | 0.145 |
| Flash | 300 | 200 | 150 | NONE | | | | 1.80 | 22.08 | 257 | 0.142 |
| Flash | 300 | 200 | 90 | NONE | | | | 2.20 | 23.32 | 229 | 0.134 |
| Flash | 300 | 200 | 65 | NONE | | | | 2.12 | 23.46 | 233 | 0.137 |

TABLE 4

| | | D.I. Water | | Additive | | | | Pre | | | |
|---|---|---|---|---|---|---|---|---|---|---|---|
| | CaO | | Start | | | | Water | dry | TriStar (BET) | | |
| Type | wt. | | Temp | | | % of | or | Water | Multi | Pore | Pore |
| Lime | (g) | (g) | (C.) | Type | (g) | CaO | Lime | (%) | Pt. | Size | Vol. |
| Kiln | 300 | 200 | 150 | DEG | 1.5 | 0.50% | Water | 0.15 | 26.32 | 138 | 0.091 |
| Kiln | 300 | 200 | 150 | DEG | 3 | 1.00% | Water | 0.53 | 26.38 | 149 | 0.098 |
| Kiln | 300 | 200 | 150 | DEG | 6 | 2.00% | Water | 0.65 | 28.55 | 140 | 0.100 |
| Kiln | 300 | 200 | 150 | DEG | 1.5 | 0.50% | Lime | 0.43 | 23.08 | 162 | 0.093 |
| Kiln | 300 | 200 | 150 | DEG | 3 | 1.00% | Lime | 0.65 | 26.65 | 144 | 0.096 |
| Kiln | 300 | 200 | 150 | DEG | 6 | 2.00% | Lime | 0.71 | 28.75 | 137 | 0.098 |
| Flash | 300 | 200 | 150 | DEG | 1.5 | 0.50% | Water | 0.26 | 30.17 | 191 | 0.144 |
| Flash | 300 | 200 | 150 | DEG | 3 | 1.00% | Water | 0.32 | 32.35 | 193 | 0.156 |
| Flash | 300 | 200 | 150 | DEG | 6 | 2.00% | Water | 0.22 | 38.96 | 172 | 0.168 |
| Flash | 300 | 200 | 150 | DEG | 1.5 | 0.50% | Lime | 0.27 | 28.22 | 206 | 0.146 |
| Flash | 300 | 200 | 150 | DEG | 3 | 1.00% | Lime | 0.36 | 35.25 | 188 | 0.166 |
| Flash | 300 | 200 | 150 | DEG | 6 | 2.00% | Lime | 0.7 | 38.48 | 181 | 0.174 |

TABLE 5

| | | D.I. Water | | Additive | | | | Pre | | | |
|---|---|---|---|---|---|---|---|---|---|---|---|
| | CaO | | Start | | | | Water | dry | TriStar (BET) | | |
| Type | wt. | | Temp | | | % of | or | Water | Multi | Pore | Pore |
| Lime | (g) | (g) | (C.) | Type | (g) | CaO | Lime | (%) | Pt. | Size | Vol. |
| Kiln | 300 | 200 | 150 | TEA | 1.5 | 0.50% | Water | 0.96 | 21.08 | 141 | 0.074 |
| Kiln | 300 | 200 | 150 | TEA | 3 | 1.00% | Water | 0.94 | 24.36 | 127 | 0.077 |
| Kiln | 300 | 200 | 150 | TEA | 6 | 2.00% | Water | 1.21 | 29.93 | 109 | 0.082 |
| Kiln | 300 | 200 | 150 | TEA | 1.5 | 0.50% | Lime | 0.46 | 20.48 | 169 | 0.087 |
| Kiln | 300 | 200 | 150 | TEA | 3 | 1.00% | Lime | 0.61 | 20.49 | 161 | 0.082 |
| Kiln | 300 | 200 | 150 | TEA | 6 | 2.00% | Lime | 0.92 | 22.87 | 137 | 0.079 |
| Flash | 300 | 200 | 150 | TEA | 1.5 | 0.50% | Water | 0.88 | 31.68 | 187 | 0.148 |
| Flash | 300 | 200 | 150 | TEA | 3 | 1.00% | Water | 1.64 | 34.32 | 174 | 0.149 |
| Flash | 300 | 200 | 150 | TEA | 6 | 2.00% | Water | 0.28 | 46.11 | 153 | 0.176 |
| Flash | 300 | 200 | 150 | TEA | 1.5 | 0.50% | Lime | 2.40 | 28.30 | 200 | 0.142 |
| Flash | 300 | 200 | 150 | TEA | 3 | 1.00% | Lime | 3.60 | 32.81 | 170 | 0.140 |
| Flash | 300 | 200 | 150 | TEA | 6 | 2.00% | Lime | 3.50 | 42.12 | 152 | 0.160 |

TABLE 6

| | | D.I. Water | | Additive | | | | Pre | | | |
|---|---|---|---|---|---|---|---|---|---|---|---|
| | CaO | | Start | | | | Water | dry | TriStar (BET) | | |
| Type | wt. | | Temp | | | % of | or | Water | Multi | Pore | Pore |
| Lime | (g) | (g) | (C.) | Type | (g) | CaO | Lime | (%) | Pt. | Size | Vol |
| Kiln | 300 | 200 | 150 | PG | 1.5 | 0.50% | Water | 0.51 | 20.47 | 179 | 0.092 |
| Kiln | 300 | 200 | 150 | PG | 3 | 1.00% | Water | 0.43 | 21.84 | 170 | 0.093 |
| Kiln | 300 | 200 | 150 | PG | 6 | 2.00% | Water | 0.65 | 23.95 | 170 | 0.102 |
| Kiln | 300 | 200 | 150 | PG | 1.5 | 0.50% | Lime | 0.47 | 21.11 | 170 | 0.089 |
| Kiln | 300 | 200 | 150 | PG | 3 | 1.00% | Lime | 0.33 | 21.76 | 186 | 0.101 |
| Kiln | 300 | 200 | 150 | PG | 6 | 2.00% | Lime | 0.55 | 24.43 | 157 | 0.096 |
| Flash | 300 | 200 | 150 | PG | 1.5 | 0.50% | Water | 1.77 | 21.84 | 255 | 0.139 |
| Flash | 300 | 200 | 150 | PG | 3 | 1.00% | Water | 0.67 | 25.69 | 224 | 0.144 |
| Flash | 300 | 200 | 150 | PG | 6 | 2.00% | Water | 0.13 | 30.32 | 188 | 0.142 |
| Flash | 300 | 200 | 150 | PG | 1.5 | 0.50% | Lime | 0.90 | 27.34 | 210 | 0.144 |
| Flash | 300 | 200 | 150 | PG | 3 | 1.00% | Lime | 0.60 | 28.54 | 209 | 0.149 |
| Flash | 300 | 200 | 150 | PG | 6 | 2.00% | Lime | 0.88 | 31.67 | 230 | 0.182 |

TABLE 7

| | | D.I. Water | | Additive | | | | Pre | | | |
|---|---|---|---|---|---|---|---|---|---|---|---|
| | CaO | | Start | | | | Water | dry | TriStar (BET) | | |
| Type | wt. | | Temp | | | % of | or | Water | Multi | Pore | Pore |
| Lime | (g) | (g) | (C.) | Type | (g) | CaO | Lime | (%) | Pt. | Size | Vol |
| Kiln | 300 | 200 | 150 | Glycerin | 3 | 1.00% | Lime | 0.59 | 20.94 | 176 | 0.092 |
| Kiln | 300 | 200 | 150 | Glycerin | 3 | 1.00% | Lime | 0.59 | 20.94 | 176 | 0.092 |
| Flash | 300 | 200 | 150 | Glycerin | 1.5 | 0.50% | Water | 0.70 | 25.49 | 246 | 0.157 |
| Flash | 300 | 200 | 150 | Glycerin | 3 | 1.00% | Water | 1.28 | 24.54 | 245 | 0.150 |
| Flash | 300 | 200 | 150 | Glycerin | 6 | 2.00% | Water | 1 48 | 25.46 | 235 | 0.150 |
| Flash | 300 | 200 | 150 | Glycerin | 1.5 | 0.50% | Lime | 1.90 | 24.34 | 244 | 0.148 |
| Flash | 300 | 200 | 150 | Glycerin | 3 | 1.00% | Lime | 0.89 | 27.37 | 226 | 0.154 |
| Flash | 300 | 200 | 150 | Glycerin | 6 | 2.00% | Lime | 1.25 | 27.08 | 224 | 0.157 |

TABLE 8

| | | D.I. Water | | | | | | Pre | | | |
|---|---|---|---|---|---|---|---|---|---|---|---|
| | CaO | | Start | Additive | | | | dry | TriStar (BET) | | |
| Type | wt. | | Temp | | | % of | Water | Water | Multi | Pore | Pore |
| Lime | (g) | (g) | (C.) | Type | (g) | CaO | or Lime | (%) | Pt. | Size | Vol |
| Flash | 300 | 200 | 150 | NONE | | | | 0.13 | 25.3 | 228 | 0.144 |
| Flash | 300 | 200 | 150 | Sugar | 1.5 | 0.50% | Water | 2.12 | 23.85 | 232 | 0.139 |
| Flash | 300 | 200 | 150 | Sugar | 3 | 1.00% | Water | 0.99 | 24.03 | 219 | 0.132 |
| Flash | 300 | 200 | 150 | Sugar | 6 | 2.00% | Water | 0.42 | 29.94 | 194 | 0.146 |
| Flash | 300 | 200 | 150 | Borax | 9 | 3.00% | Water | 3.46 | 22.81 | 189 | 0.108 |

For the preparations made for, and reflected in, Tables 3 through 8, about 300 g of calcium oxide, either produced by lime kiln calcination or calcium oxide produced by flash calcination, was mixed with about 200 g of water at about 150° C. (except for two examples shown in Table 3 that were produced with water at about 90° C. or about 65° C.). For Tables 4 through 8, either the water or the calcium oxide was doped with an additive, and each table indicates what additive was used and to which constituent (water or calcium oxide) the additive was added. The water and the calcium oxide (as well as the additive) were mixed in a bowl using a spatula in order to produce calcium hydroxide. The moisture content of the resulting calcium hydroxide mixture was then determined. Subsequently, for each of the preparations made from calcium oxide from a flash calcination process, the dry calcium hydroxide was milled. Finally, the BET surface area of the dried and milled calcium hydroxide was determined.

As can be seen in the testing shown in Table 3, which results were intended to serve as control examples for some tests, the multi-point BET surface area for calcium hydroxide from lime kiln calcium oxide and from flash calcined calcium oxide (each without any additives) were determined. This determination shows the expected additive-free multi-point BET surface area, pore size, and pore volume values. Of note, these results show that the reactivity of calcium hydroxide from flash calcined calcium oxide is greater than that derived from lime kiln calcined calcium oxide. Further, this data shows that lower processing temperatures for the water used in forming the calcium hydroxide from calcium oxide results in increased reactivity.

As can be seen in the testing shown in Table 4, the multi-point BET surface area determination increased as additives were added for both the calcium oxide from lime kiln calcination and from the calcium oxide from flash calcination. This was true regardless of the amount of additives used, although the BET surface area also generally increased with increased amounts of additives. On the other hand, the determined pore size dropped considerably with the addition of additives. The determined pore volume typically increased with increased amounts of additives regardless of where the additives were added (i.e., to the calcium oxide or the water). Accordingly, the use of DEG as an additive to calcium oxide may increase the reactivity of subsequently produced calcium hydroxide, regardless of the source of calcium oxide. However, overall, calcium oxide produced by flash calcination resulted in a generally higher determined BET surface area, higher pore size, and higher pore volume.

As can be seen in the testing shown in Table 5, the multi-point BET surface area determination increased with increased amounts of additives being included in the calcium oxide from flash calcination. This was true regardless of the amount of additives used, although the BET surface area also generally increased with increased amounts of additives. On the other hand, the BET surface area determination decreased slightly as additives were added to the calcium oxide from flash calcination until the amount of additives reached the higher-tested amounts. This was true regardless of where the additives were added (i.e., to the calcium oxide or the water), although the TEA added to the water had a greater effect at the higher-tested amounts. Pore size decreased across these tests compared to the control amounts in Table 3. Pore volume for the smallest amounts of additives featured slight decreases for the smallest amount of additive for the lime kiln calcined calcium oxide, but the pore volumes increased to above the control amounts with the addition of more additives. For the flash calcined calcium oxide, the pore volume increased as the amount of additives increased. For some applications, the best and most reactive examples were obtained using TEA as an additive when the TEA was first added to the calcium oxide rather than the water.

As can be seen in the testing shown in Table 6, the multi-point BET surface area determination increased as additives were added to the calcium oxide from flash calcination (except for the lowest amount of additives added via the water). This was true regardless of the amount of additives used (with the above exception), although the BET surface area also generally increased as the amounts of additives increased. On the other hand, the BET surface area determination decreased slightly as additives were added to the lime kiln calcined calcium oxide until the amount of additives reached the higher-tested amounts. This was true regardless of where the additives were added (i.e., to the calcium oxide or the water), although the propylene glycol added to the water had a greater effect at the higher-tested amounts. Pore size decreased in all but two of these tests compared to the control amounts in Table 3. Pore volume varied up and down when compared to control amounts in Table 3.

Some expected generalizations regarding the above test results (Table 3 through Table 6) will now be discussed. First, generally speaking, the BET surface area of calcium hydroxide produced from calcium oxide derived from flash calcination was greater than that of similar calcium hydroxide produced from calcium oxide derived from lime kiln calcination. Similarly, the pore volume and pore size was typically greater for calcium oxide derived from flash calcination. Each of the DEG, TEA, and propylene glycol additives tended to increase BET surface area without adversely affecting pore volume. Further, and finally, for these three additives, whether the additives are added to the water or to the calcium oxide does not have a significant effect on the overall results, although some general trends are discussed herein.

As can be seen in the testing shown in Table 7, the multi-point BET surface area determination increased as additives were added to the flash calcination calcium oxide. This was true regardless of the amount of additives used, although the BET surface area also generally increased as the amounts of additives increased (with one exception). On the other hand, the BET surface area determination varied up and down as additives were added to the lime kiln calcined calcium oxide—when the glycerin additives were added to the calcium oxide, the BET surface area decreased, but when added to the water, the BET surface area increased. For the lime kiln calcined calcium oxide, the pore size and pore volume also increased when the additives were in the water but decreased when in the calcium oxide. For the flash calcined calcium oxide, the pore size generally decreased (with some exceptions) while the pore volume generally increased.

As can be seen in the testing shown in Table 8, only flash calcined calcium oxide was used to prepare these examples, some of which had sugar or borax added. In this case, the first example of Table 8 served as a control example. Compared with this control example, the addition of sugar decreased the determined BET surface area, except for the largest amount of sugar added. The addition of sugar increased the pore size for the smallest amount of sugar added, but decreased the pore size for the two larger amounts of sugar added. Further, the addition of sugar decreased the pore volume for the two smaller amounts of sugar added, but increased pore volume for the largest amount of sugar added. The addition of borax reduced the BET surface area, decreased the pore size, and decreased the pore volume.

### Example 3

As can be seen in the testing shown in Table 9, only flash calcined calcium oxide was used to prepare these examples, some of which had DEG added. Of particular note, all examples in this table were produced using water at 65° C. For each example, except the second example, the water and the calcium oxide (as well as the additive) were mixed in a bowl using a spatula in order to produce calcium hydroxide. For the second example, the water and the calcium oxide were mixed by first spritzing the water onto the calcium oxide and then mixing the mixture. Further, the first three examples used between about 180 g and about 210 g of water while the second three examples used about 330 g of water. Thus, the first three examples used a dry hydrate process while the second three examples used a damp hydrate process. In each case, the damp hydrate process resulted in increased BET surface area over the dry hydrate process. Further, the addition of DEG tended to increase the BET surface area and decrease the pore volume and pore size. Also, it should be noted that each example in Table 9 was subjected to drying after having water added to form calcium hydroxide.

TABLE 9

| | CaO | Water | | Additive | | | Pre dry | TriStar (BET) | | | |
|---|---|---|---|---|---|---|---|---|---|---|---|
| Type | wt. | | Start | | | % of | Moisture | Single | Multi | Pore | Pore |
| Lime | (g) | (g) | Temp (C.) | Type | (g) | CaO | (%) | Pt. | Pt. | Size | Vol |
| Flash | 300 | 210 | 65 | | | | 6.7 | 27.6 | 28.37 | 216 | 0.153 |
| Flash | 300 | 200 | 65 | | | | 7.35 | 22.71 | 23.2 | 195 | 0.113 |
| Flash | 300 | 180 | 65 | DEG | 3 | 1 | 1.65 | 31.16 | 32.43 | | |
| Flash | 300 | 330 | 65 | | | | 27.4 | 33.46 | 34.35 | 269 | 0.231 |
| Flash | 300 | 330 | 65 | DEG | 1 | 0.33 | 29.2 | 39.56 | 40.8 | 214 | 0.128 |
| Flash | 300 | 300 | 65 | DEG | 3 | 1 | 22.42 | 48.13 | 50.1 | 173 | 0.216 |

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

Finally, the qualifier “generally,” and similar qualifiers as used in the present case, would be understood by one of ordinary skill in the art to accommodate recognizable attempts to conform a device to the qualified term, which may nevertheless fall short of doing so. This may be because related terms are purely geometric constructs having no real-world equivalent (for example, no sphere is every perfectly spherical), or there may be other reasons why a given term may be more precise than its real-world equivalent. Variations from geometric, mathematical, and other descriptions are unavoidable due to, among other things, manufacturing tolerances resulting in shape variations, defects and imperfections, non-uniform thermal expansion, and natural wear. Moreover, there exists for every object a level of magnification at which geometric, mathematical, and other precise descriptors fail, due to the nature of matter. One of ordinary skill would thus understand the term “generally” and relationships contemplated herein, regardless of the inclusion of such qualifiers to include a range of variations from the literal geometric, mathematic, or other meaning of the term in view of these and other considerations.

1. A method for forming a sorbent composition with improved acid gas reactivity comprising:
forming a first calcium oxide particulate in a lime kiln;
forming a second calcium oxide particulate in a flash calciner;
mixing said first calcium oxide particulate with said second calcium oxide particulate to form a calcium oxide particulate mixture;
slaking said calcium oxide particulate mixture with water to form calcium hydroxide particles; and
forming a sorbent composition from said calcium hydroxide particles;
wherein said calcium hydroxide particles have a reactivity of less than 10 seconds and a BET surface area of 20 m²/g or greater; and
wherein said reactivity is an amount of time it takes said calcium hydroxide particles to neutralize in citric acid, said citric acid having a mass greater than 10 times a mass of said calcium hydroxide particles.

2. The method of claim 1 wherein said reactivity is less than 8 seconds.

3. The method of claim 1 wherein said reactivity is less than 4 seconds.

4. The method of claim 1 wherein said reactivity is less than 3 seconds.

5. The method of claim 1 wherein said reactivity is between about 2 seconds and about 5 seconds.

6. The method of claim 1 wherein said mass of said calcium hydroxide particles is about 1.7 grams and mass of citric acid is about 26 grams.

7. The method of claim 1 wherein said sorbent composition comprises at least 95% calcium hydroxide particles.

8. The method of claim 1 wherein said water includes an additive.

9. The method of claim 8 wherein said additive comprises: an additive to increase BET surface area, an additive to increase reactivity, or both.

10. The method of claim 9 wherein said additive to increase reactivity is selected from the group consisting of: sugars and lignosulfonate salts.

11. The method of claim 9 wherein said additive to increase reactivity is between 0.75% to 1.25% of said calcium oxide particulate by weight.

12. The method of claim 9 wherein said additive to increase BET surface area is selected from the group consisting of: glycols derived from ethylene oxide and amines produced from reacting ethylene oxide with ammonia.

13. The method of claim 9 wherein said additive to increase BET surface area is between 0.5% to 3% of said calcium oxide particulate by weight.

14. The method of claim 1 wherein said second calcium oxide particulate comprises at least 20% of said calcium oxide particulate mixture.

15. The method of claim 1 wherein said second calcium oxide particulate comprises at least 40% of said calcium oxide particulate mixture.

16. The method of claim 1 wherein said second calcium oxide particulate comprises at least 50% of said calcium oxide particulate mixture.

17. The method of claim 1 wherein said second calcium oxide particulate comprises at least 60% of said calcium oxide particulate mixture.

18. The method of claim 1 wherein said second calcium oxide particulate comprises at least 80% of said calcium oxide particulate mixture.

19. The method of claim 1 wherein said second calcium oxide particulate comprises at least 90% of said calcium oxide particulate mixture.

20. A method for forming a sorbent composition with improved acid gas reactivity comprising:
forming a calcium oxide particulate in a flash calciner;
slaking said calcium oxide particulate with water to form calcium hydroxide particles; and
forming a sorbent composition from said calcium hydroxide particles;
wherein said calcium hydroxide particles have a reactivity of less than 10 seconds and a BET surface area of 20 m²/g or greater; and
wherein said reactivity is an amount of time it takes said calcium hydroxide particles to neutralize in citric acid, said citric acid having a mass greater than 10 times a mass of said calcium hydroxide particles.
